(19) United States
(12) Patent Application Publication
(10) Pub. No.: US 2003/0014507 A1
(43) Pub. Date: Jan. 16, 2003

(54) Method and system for providing performance analysis for clusters

(75) Inventors: Randal Lee Bertram, Raleigh, NC (US); Antonio Abbondanzio, Raleigh, NC (US); Janet Anne Brewer, Pittsboro, NC (US); F.S. Hunter Krauss, Raleigh, NC (US); James Franklin Macon JR., Apex, NC (US); Gregory Joseph McKnight, Chapel Hill, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 09/805,413

(22) Filed: Mar. 13, 2001

(51) Int. Cl. G06F 15/173

(52) U.S. Cl. 709/223

(57) ABSTRACT

A method and system for providing performance analysis on a system including a cluster is described. The cluster includes a plurality of nodes. The method and system include obtaining data for the plurality of nodes and analyzing the data. The data obtained relates to a plurality of monitors for the plurality of nodes. The analysis is used to determine whether performance of the cluster can be improved. The method and system also include providing at least one remedy to improve performance of the cluster if the performance of the cluster can be improved. The at least one remedy is capable of including a cluster level remedy.

### CROSS-REFERENCE TO RELATED APPLICATIONS

The present application is related to co-pending U.S. patent application Ser. No. 09/255,955, entitled “SYSTEM AND METHOD FOR IDENTIFYING LATENT COMPUTER SYSTEM BOTTLENECKS AND FOR MAKING RECOMMENDATIONS FOR IMPROVING COMPUTER SYSTEM PERFORMANCE”, filed on Feb. 23, 2000 and assigned to the assignee of the present application. The present application is also related to co-pending U.S. patent application Ser. No. 09/256,452, entitled “SYSTEM AND METHOD FOR MONITORING AND ANALYZING COMPUTER SYSTEM PERFORMANCE AND MAKING RECOMMENDATIONS FOR IMPROVING IT” (RAL919990009US), filed on Feb. 23, 1999 and assigned to the assignee of the present application. The present application is also related to co-pending U.S. patent application Ser. No. 09/255,680, entitled “SYSTEM AND METHOD FOR PREDICTING COMPUTER SYSTEM PERFORMANCE AND FOR MAKING RECOMMENDATIONS FOR IMPROVING ITS PERFORMANCE” (RAL919990011US1), filed on Feb. 23, 1999 and assigned to the assignee of the present application.

### FIELD OF THE INVENTION

The present invention relates to clusters, and more particularly to a method and system for performing performance analysis on clusters.

### BACKGROUND OF THE INVENTION

Clusters are increasingly used in computer networks. FIG. 1 depicts a block diagram of a conventional cluster 10. The conventional cluster 10 includes two computer systems 20 and 30, that are typically servers. Each computer system 20 and 30 is known as a node. Thus, the conventional cluster 10 includes two nodes 20 and 30. However, another cluster (not shown) could have another, higher number of nodes. Clusters such as the conventional cluster 10 are typically used for business critical applications because the conventional cluster 10 provides several advantages. The conventional cluster 10 is more reliable than a single server because the workload in the conventional cluster 10 can be distributed between the nodes 20 and 30. Thus, if one of the nodes 20 or 30 fails, the remaining node 30 or 20, respectively, may assume at least a portion of the workload of the failed node. The conventional cluster 10 also provides for greater scalability. Use of multiple servers 20 and 30 allows the workload to be evenly distributed within the nodes 20 and 30. If additional nodes (not shown) are added, the workload can be distributed between all nodes in the conventional cluster 10. Thus, the conventional cluster 10 is scalable. In addition, the conventional cluster 10 is typically cheaper than the alternative. In order to produce equivalent performance and availability as the conventional cluster 10, a large-scale computer system that is typically proprietary would be used. Such a large-scale computer system is generally expensive. Consequently, the conventional cluster 10 provides substantially the same performance as such a large-scale computer system while costing less.

Although the conventional cluster 10 provides the above-mentioned benefits, one of ordinary skill in the art will readily realize that it is desirable to monitor performance of the conventional cluster during use. Performance of the conventional cluster 10 could vary throughout its use. For example, the conventional cluster 10 may be one computer system of many in a network. One or more of the nodes 20 or 30 of the conventional cluster 10 may have its memory almost full or may be taking a long time to access its disk. Phenomena such as these result in the nodes 20 and 30 in the cluster 10 having lower than desired performance. Therefore, the performance of the entire network is adversely affected. For example, suppose there is a bottleneck in the conventional cluster 10. A bottleneck in a cluster occurs when a component in a node of the conventional cluster, such as the CPU of a node, has high enough usage to cause delays. For example, the utilization of the CPU of the node, the interconnects coupled to the node, the memory of the node or the disk of the node could be high enough to cause a delay in the node performing some of its tasks. Because of the bottleneck, processing can be greatly slowed due to the time taken to access a node 20 or 30 of the conventional cluster 10. This bottleneck in one or more of the nodes of the conventional cluster 10 adversely affects performance of the conventional cluster 10. This bottleneck may slow performance of the network as a whole, for example because of communication routed through the conventional cluster 10. A user, such as a network administrator, would then typically manually determine the cause of the reduced performance of the network and the conventional cluster 10 and determine what action to take in response. In addition, the performance of the conventional cluster 10 may vary over relatively small time scales. For example, a bottleneck could arise in just minutes, then resolve itself or last for several hours. Thus, performance of the conventional cluster 10 could change in a relatively short time.

Accordingly, what is needed is a system and method for analyzing performance of networks including clusters and to provide remedies that may be specific to the cluster. The present invention addresses such a need.

### SUMMARY OF THE INVENTION

The present invention provides a method and system for providing performance analysis on a system including a cluster. The cluster includes a plurality of nodes. The method and system comprise obtaining data for the plurality of nodes and analyzing the data. The data obtained relates to a plurality of monitors for the plurality of nodes. The analysis is used to determine whether performance of the cluster can be improved. The method and system also comprise providing at least one remedy to improve performance of the cluster if the performance of the cluster can be improved. The at least one remedy is capable of including a cluster level remedy. For example, a bottleneck in a node of the plurality of nodes may adversely affect performance of the cluster. The cluster level remedy could include recommendations for addressing the bottleneck that relate to the nodes of the cluster. For example, the cluster level remedy could include moving workload from the node having the bottleneck to the plurality of nodes, adding another node to the cluster, or other remedies. As a result, the performance of the node and, therefore, the cluster can improve.

According to the system and method disclosed herein, the present invention provides the ability to closely monitor the performance of a cluster and solve issues that adversely affect performance, such as bottlenecks in the nodes of the cluster.

### BRIEF DESCRIPTION OF THE DRAWINGS

FIG. 1 is a block diagram of a conventional cluster.

FIG. 2 is a block diagram of a network including clusters in which one embodiment of a system in accordance with the present invention operates.

FIG. 3 is a high-level flow chart of one embodiment of a method in accordance with the present invention for providing performance analysis on clusters.

FIG. 4 is a more detailed flow chart of one embodiment of a method in accordance with the present invention for providing performance analysis on clusters.

FIGS. 5A-5E depict a flow chart of a preferred embodiment of a method in accordance with the present invention for providing performance analysis on clusters.

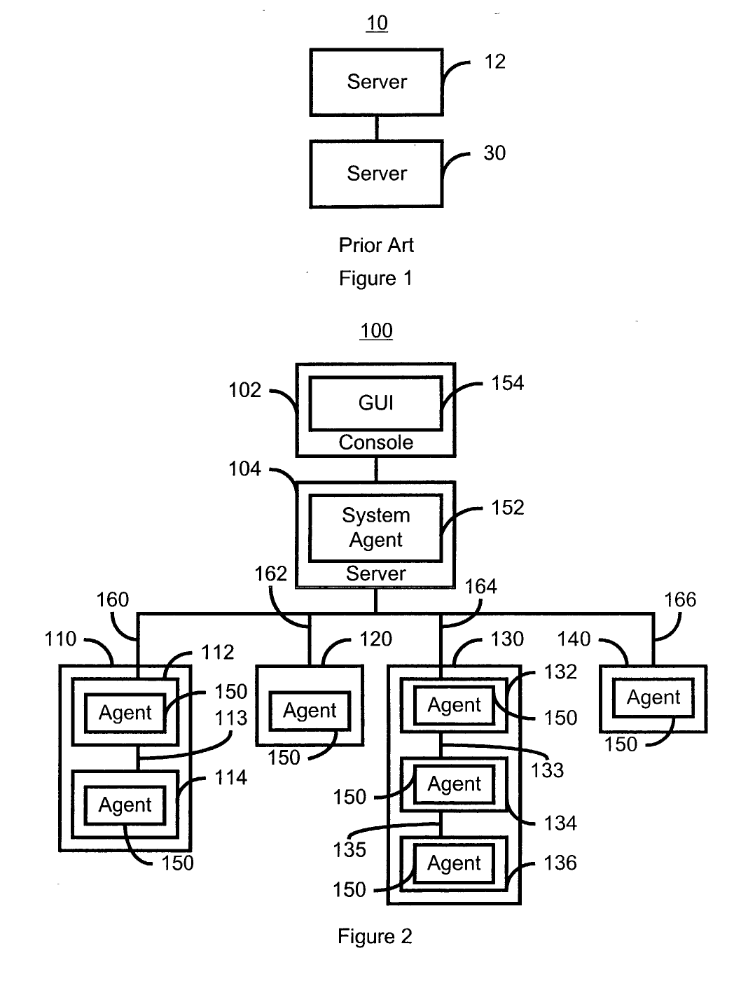

### DETAILED DESCRIPTION OF THE INVENTION

The present invention relates to an improvement in computer systems. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

It is desirable to monitor the performance of computer systems within a network. One method for providing performance analysis on computer systems, typically servers, in a network is described in co-pending U.S. patent application Ser. No. 09/255,955, entitled “SYSTEM AND METHOD FOR IDENTIFYING LATENT COMPUTER SYSTEM BOTTLENECKS AND FOR MAKING RECOMMENDATIONS FOR IMPROVING COMPUTER SYSTEM PERFORMANCE”, filed on Feb. 23, 2000 and assigned to the assignee of the present application. The present application is also related to co-pending U.S. patent application Ser. No. 09/256,452, entitled “SYSTEM AND METHOD FOR MONITORING AND ANALYZING COMPUTER SYSTEM PERFORMANCE AND MAKING RECOMMENDATIONS FOR IMPROVING IT” (RAL919990009US), filed on Feb. 23, 1999 and assigned to the assignee of the present application. The present application is also related to co-pending U.S. patent application Ser. No. 09/255,680, entitled “SYSTEM AND METHOD FOR PREDICTING COMPUTER SYSTEM PERFORMANCE AND FOR MAKING RECOMMENDATIONS FOR IMPROVING ITS PERFORMANCE” (RAL919990011US1), filed on Feb. 23, 1999 and assigned to the assignee of the present application. Applicant hereby incorporates by reference the above-mentioned co-pending applications. Using the method and system described in the above-mentioned co-pending applications, performance data can be provided and analyzed for each computer system in a network. The performance data provided can indicate changes that occur in relatively short time scales. This is because data is sampled frequently, every minute in one embodiment. In addition, the data is analyzed to determine the presence of bottlenecks and latent bottlenecks. A latent bottleneck is, for example, a bottleneck that will occur when another, larger bottleneck has been cleared. The method and system described in the above-mentioned co-pending applications also provide remedies for removing bottlenecks and latent bottlenecks. These remedies are appropriate for a network having computer systems that have only a single node.

Clusters, which typically include multiple nodes, are of increasing utility in many applications. Clusters provide many advantages, including increased reliability and scalability. However, performance for clusters can vary. In addition, clusters can still be subject to phenomena such as bottlenecks and latent bottlenecks in the nodes of the cluster, which adversely affect performance of the cluster and the network. It is, therefore, still desirable to monitor and analyze performance data for networks which employ clusters. Although the method and system described in the above-mentioned co-pending application work well for their intended purpose, they do not account for the presence of multiple nodes in a cluster. Instead, the method and system described in the above-mentioned co-pending application consider each computer system to include a single node (i.e. be a single computer system rather than a cluster). Consequently, the method and system described in the above-mentioned co-pending application may not provide sufficient information relating to performance of a network which includes clusters.

The present invention provides a method and system for providing performance analysis on a system including a cluster. The cluster includes a plurality of nodes. The method and system comprise obtaining data for the plurality of nodes and analyzing the data. The data obtained relates to a plurality of monitors for the plurality of nodes. The analysis is used to determine whether performance of the cluster can be improved. The method and system also comprise providing at least one remedy to improve performance of the cluster if the performance of the cluster can be improved. The at least one remedy is capable of including a cluster level remedy.

The present invention will be described in terms of a particular network having a certain number of clusters. However, one of ordinary skill in the art will readily recognize that this method and system will operate effectively for other networks and other clusters. For example, the method and system could be used on a single cluster, multiple clusters, and clusters having a different number of nodes. Furthermore, the present invention is described in terms of particular methods having certain steps in a given order. However, one of ordinary skill in the art will readily recognize that the method and system can include other steps in another order and different components.

To more particularly illustrate the method and system in accordance with the present invention, refer now to FIG. 2, depicting one embodiment of a network 100 in which the system and method in accordance with the present invention are utilized. The network 100 includes computer systems 104, 110, 120, 130 and 140, as well as console 102. The computer systems 110 and 130 are clusters. Thus, the cluster 110 includes two nodes 112 and 114 and the cluster 130 includes three nodes 132, 134 and 136. Each node 112, 114, 132, 134 and 136 is preferably a server. The nodes 112 and 114 are connected through interconnect 113. The nodes 132 and 134 and 134 and 136 are coupled using interconnects 133 and 135, respectively.

The console 102 is utilized by a user, such as a system administrator, to request performance data on the network 100. Although only one console 102 is depicted, the network 100 may include multiple consoles from which the method and system in accordance with the present invention can be implemented. The system preferably includes an agent 150 located in each node 112, 114, 132, 134, and 136 and in each computer system 120 and 140. The nodes 112, 114, 132, 134 and 136 and the computer systems 120 and 140 are preferably servers. In addition, for clarity, portions of the nodes 112, 114, 132, 134 and 136 and the computer systems 120 and 140 are not depicted. For example, the disks, memory, and CPUs of the nodes 112, 114, 132, 134, and 136 and the computer system 120 and 140 are not shown. The agents 150 are utilized to obtain performance data about each of the computer systems 110, 120, 130 and 140, including data about each of the nodes 112, 114, 132, 134 and 136. The server 104 includes a system agent 152. Upon receiving a request from the console 102, the system agent 150 requests reports on performance data from the agents 150, compiles the data from the agents 150 and can store the data on the memory for the server 104. The performance data is provided to the user via a graphical user interface (“GUI”) 154 on console 102. The GUI 154 also allows the user to request performance data and otherwise interface with the system agent 152 and the agents 154. Thus, the system in accordance with the present invention includes at least the agents 150, the system agent 152 and the GUI 154.

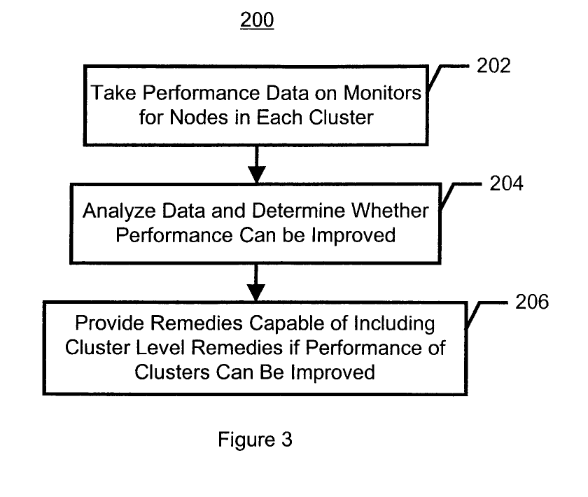

FIG. 3 is a high-level flow chart of one embodiment of a method 200 in accordance with the present invention. The method 200 is described in conjunction with the system 100 depicted in FIG. 2. Referring to FIGS. 2 and 3, the method 200 is preferably performed by a combination of the agents 150, the system agent 152 and the GUI 154. The method 200 is described in the context of providing performance analysis only for the clusters 110 and 130. However, the method 200 can be extended to use with the computer systems 120 and 140 containing only a single system. In addition, the method 200 could be applied to a single cluster.

The method 200 preferably commences after certain information has been provided. In a preferred embodiment, the name of each cluster 110 and 130 and the nodes 112 and 114 and 132, 134 and 136, respectively, are indicated. In addition, an indication of whether a particular node is passive is provided. A passive node is one which is designed to be used as a backup only. Furthermore, the maximum number of nodes and the type of LAN adapter used for the interconnects 113, 133 and 135 are provided. In one embodiment, the cluster type is also indicated. One type of cluster is high-availability, which typically contains a passive node so that it can be assured that the cluster is always available. A second type of cluster is scalable and thus has its workload distributed throughout its nodes.

Data for a plurality of monitors is obtained from each of the nodes 112 and 114 in the cluster 110 and each of the nodes 132, 134 and 136 of the cluster 130, via step 202. The monitors relate to the performance of the nodes 112, 114, 132, 134 and 136. In a preferred embodiment, the monitors include the disk utilization, CPU utilization, memory usage and network utilization. In addition, other monitors might be specified by the user. The data may be sampled frequently, for example every minute or several times per hour. In a preferred embodiment, the user can indicate the frequency of sampling for each monitor and the times for which each monitor is sampled. The user might also indicate the minimum or maximum data points to be sampled. Thus, through step 202, performance data is obtained for each node 112 and 114 and 132, 134 and 136 in the clusters 110 and 130.

The performance data obtained in step 202 is then analyzed, via step 204. Using this analysis, it can be determined whether performance of the clusters 110 and 130 can be improved. For example, step 204 may include averaging the data for the monitors, determining the minimum and maximum values for the monitors, or performing other operations on the data. Step 204 may also include determining whether one or more of the monitors have a bottleneck or a latent bottleneck in one or more of the nodes 112 and 114 or 132, 134 and 136. Based on the performance data obtained in step 202, the method 200 can forecast future bottlenecks. A bottleneck for a monitor can be defined to occur when the monitor rises above a particular threshold. A latent bottleneck can be defined to occur when the monitor would become bottlenecked if another bottleneck is cleared. In a preferred embodiment, the analysis performed in step 204 also indicates when a cluster level bottleneck may occur. A cluster level bottleneck occurs when nodes 112 and 114 or 132, 134 and 136 are used heavily enough that a failure of one node 112 or 114, or 132, 134 or 136 will cause a bottleneck in one or more of the remaining nodes 112, 114, 132, 134 or 136. In addition, the analysis of step 206 preferably diagnoses bottlenecks of the nodes 112, 114, 132, 134 and 136 that involve the interconnects 113 and 133 and 135 separately from bottlenecks of the nodes 112, 114, 132, 134 and 136 interconnects 160, 162, 164 and 166 of the network 100 between computer systems 110, 120, 130 and 140. Also in a preferred embodiment, passive nodes of a cluster 110 and 120 are identified. Step 204 also preferably performs analysis on the combination of nodes, for example to determine when the entire cluster 110 and 130 runs out of capacity. Such a bottleneck of the entire cluster may occur when all nodes 112 and 114 and 132, 134 and 136, respectively, in the cluster would run out of capacity. Thus, a bottleneck of the entire cluster can be detected in step 204. For each bottleneck, the monitor which is bottlenecked, the frequency of the bottleneck for the particular node, counters which are used in generating the remedies described below, the timestamp of when the bottleneck last commenced and a timestamp for when the bottleneck last ended are also preferably provided in step 204.

If performance can be improved, then at least one remedy is provided, via step 206. The at least one remedy can include a cluster level remedy. The cluster level remedy is one which is capable of being performed for a cluster, but not for a system having only a single node. For example, cluster level remedies may include moving resources between nodes, adding nodes, or warning that a particular node may fail so that the user can make changes to the cluster and the node's workload need not be absorbed by remaining nodes. In order to move workload between nodes, resource groups associated with an application may be reconfigured. In addition, this recommendation is preferably given when there is at least one node in the cluster that can consistently absorb the load. The candidates for receiving the workload are preferably ordered starting with the node best able to absorb the workload. In addition, the recommendation to transfer workload from a bottlenecked node may suggest that the workload be transferred to multiple remaining nodes. The recommendation of adding a new node to the cluster is preferably given only when the remaining cluster level remedies cannot resolve the bottleneck. Furthermore, in a preferred embodiment, the cluster level remedies will attempt to exclude moving workload to a passive node. For example, in one embodiment, the cluster level remedies provided will not include moving workload to a passive node unless this option is required to allow the cluster 110 and 130 to continue functioning as desired. In addition, the cluster level remedies provided are only those which may be performed without adversely affecting the cluster 110 or 130. For example, suppose that the CPU utilization for the node 112 is bottlenecked. A cluster level remedy of moving a portion of the workload of the node 112 to the node 114 will only be provided if the portion of the workload can be moved to the node 114 without causing a bottleneck in the node 114.

Although cluster level remedies may be provided in step 206, other remedies that are not based on the cluster are also preferably provided. For example, remedies such as increasing the memory of a particular node or replacing the current CPU with a faster CPU better able to handle the workload of the node may also be suggested.

Thus, performance analysis can be provided on the clusters 110 and 130 using the method 200. Performance data on monitors for each node 112 and 114 and 132, 134 and 136 in the nodes 110 and 130, respectively, can be accumulated and analyzed through the method 200. Furthermore, the method 200 can provide cluster level remedies for improving performance of the clusters 110 and 130 and, therefore, of the network 100 in which the clusters 110 and 130 reside.

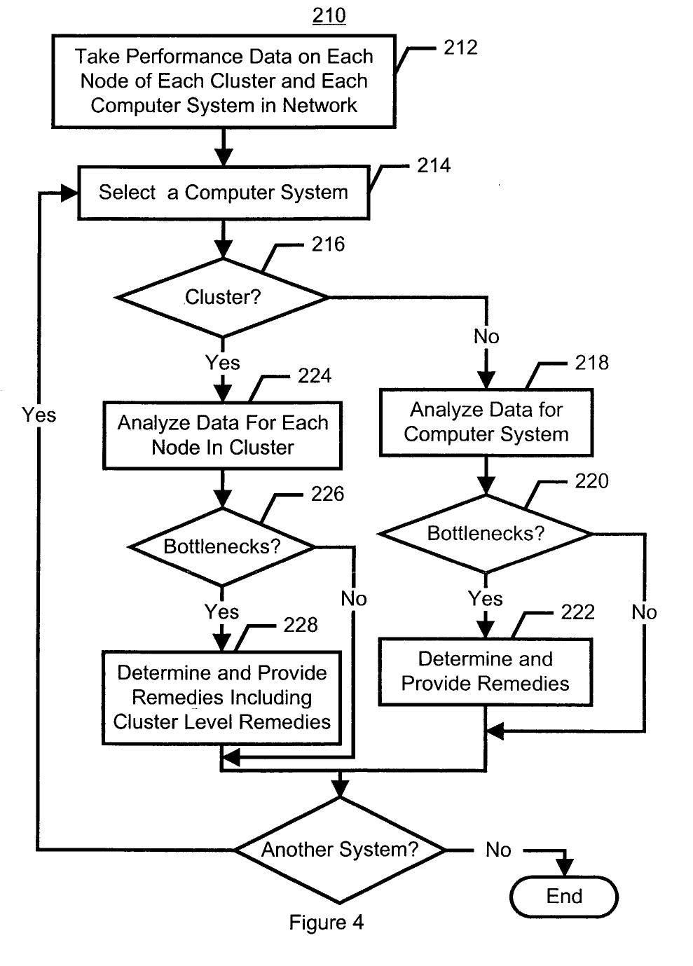

FIG. 4 depicts a more detailed flow chart of a method 210 in accordance with the present invention for providing performance analysis on a network, such as the network 100, that includes clusters. The method 210 will, therefore, be described in conjunction with the network 100 depicted in FIG. 2. Referring to FIGS. 2 and 4, performance data is obtained for each of the computer systems 110, 120, 130 and 104, via step 212. Step 212 includes obtaining performance data for the nodes 112 and 114 and the nodes 132, 134 and 136 of the clusters 110 and 130, respectively. The performance data is obtained for monitors for each computer system. The plurality of monitors preferably includes CPU utilization, memory utilization, disk utilization and network utilization. The plurality of monitors might also include other monitors.

A computer system is selected for analysis, via step 214. It is determined whether the selected computer system is a cluster, via step 216. If the computer system selected is not a cluster, then performance data are analyzed for the entire system, via step 218. Thus, step 218 is performed for the computer systems 120 and 140. Part of the analysis performed in step 218 is the forecasting of bottlenecks and latent bottlenecks for the monitors of the computer system 120 or 140, similar to the method 200 depicted in FIG. 3. Referring back to FIGS. 2 and 4, it is then determined whether a bottleneck or a latent bottleneck was indicated by the analysis, via step 220. If a bottleneck was found, then remedies are provided, via step 222. The remedies provided in step 222 will not include cluster level remedies because the remedies are for systems that do not include multiple nodes.

If it is determined in step 216 that the system selected is a node in a cluster, then the performance data are analyzed for each of the nodes in the cluster, via step 224. Step 224 thus analyzes data for the nodes 112 and 114 or the nodes 132, 134 and 136 of the clusters 110 and 130, respectively. Step 224 includes diagnosing bottlenecks for each node, as described above with respect to the method 200 depicted in FIG. 3. Referring back to FIGS. 2 and 4, it is determined whether a bottleneck (latent or otherwise) was detected, via step 226. If so, then the appropriate remedies are provided, via step 228. The remedies provided in step 228 can include cluster level remedies, where appropriate.

Once the performance data for the computer system has been analyzed and remedies provided based on whether the computer system was a cluster, it is determined whether another computer system remains to be analyzed, via step 230. If so, then another computer system selected, via step 214. Otherwise, the method terminates in step 232.

Thus, using the method 210, performance data can be provided and analyzed for the network 100. The results can also be provided to the user. Data for both clusters 110 and 130 and computer systems 120 and 140 can be obtained and analyzed. Furthermore, the appropriate remedies for performance issues can be provided for both the clusters 110 and 130 and the computer systems 130 and 140. Although not explicitly depicted in the method 210, the performance data as well as the remedies can be provided to the user, preferably through a GUI 154. Thus, a user can view the performance data and obtain remedies for issues such as bottlenecks. Consequently, a user can better control the network 100 to provide the desired performance.

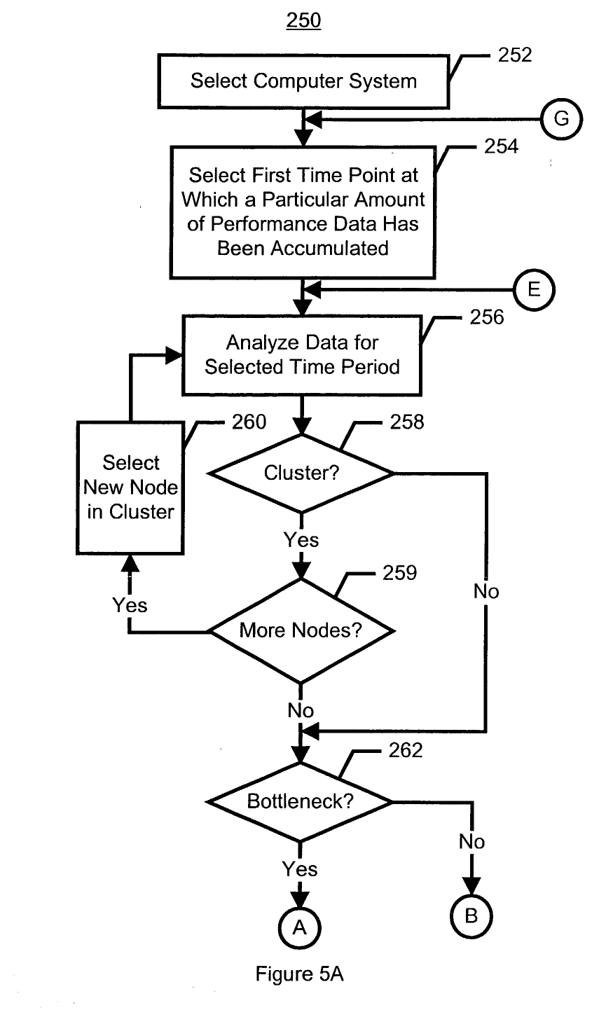

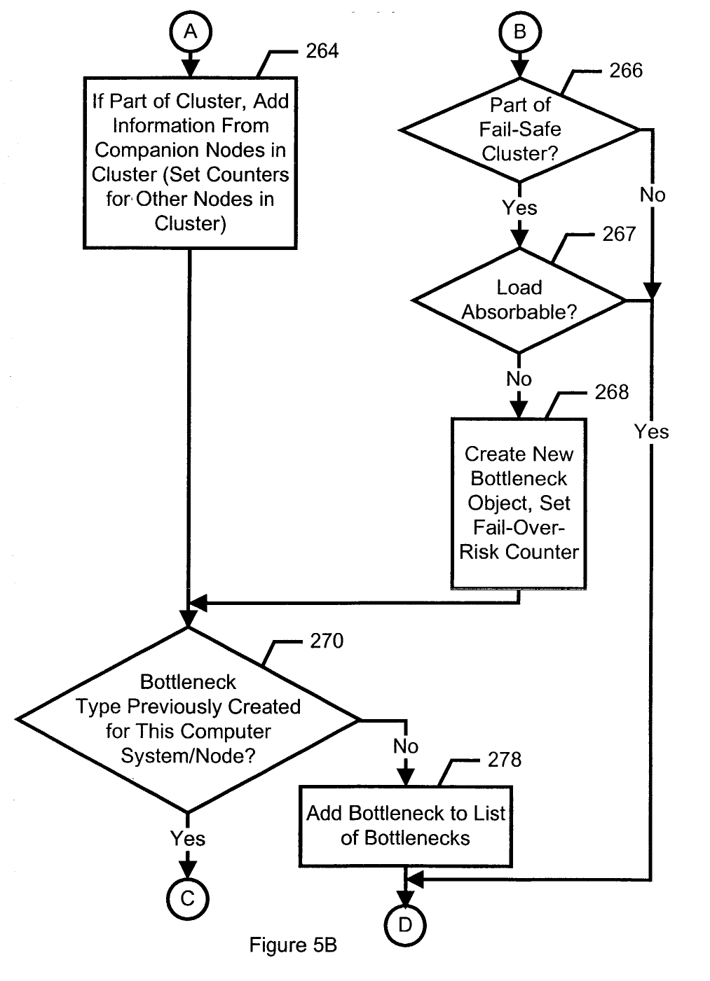

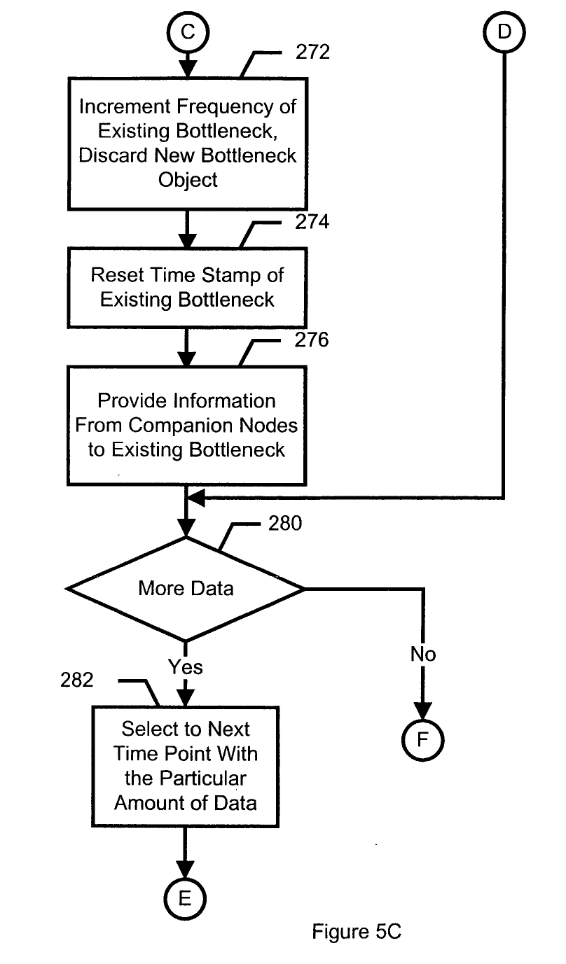

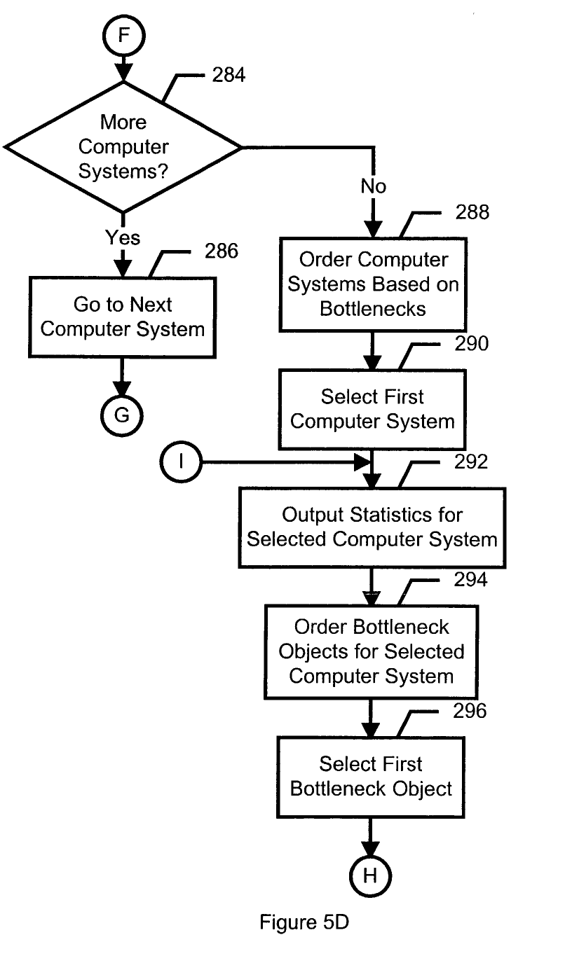

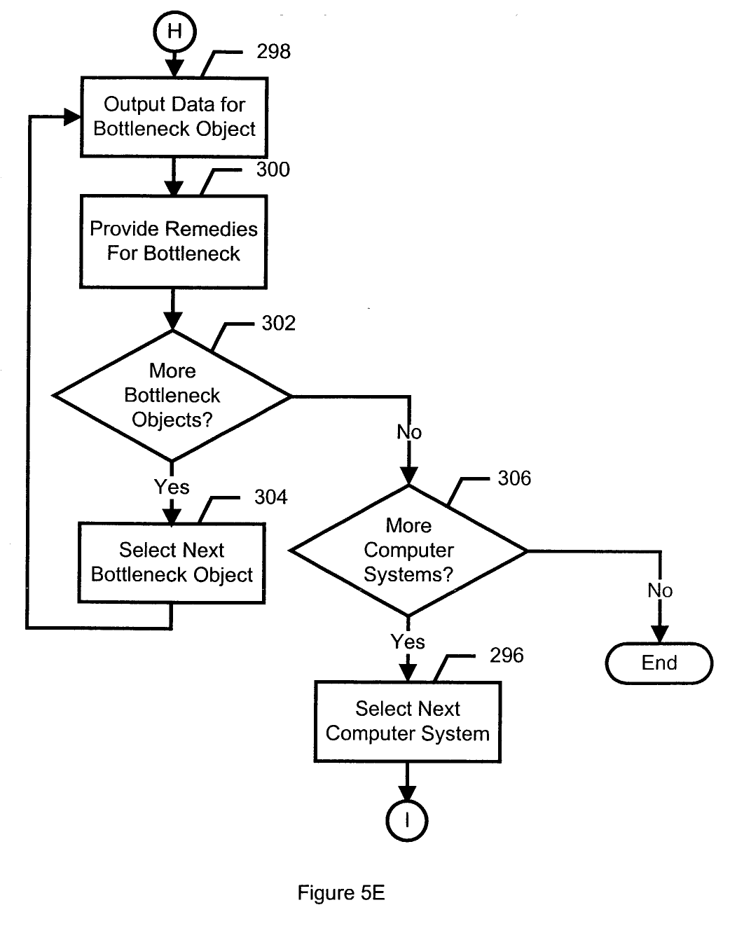

FIGS. 5A-5E depicts a preferred embodiment of a method 250 in accordance with the present invention for analyzing and providing performance data to a user. The method 250 preferably commences after certain information has been provided. In a preferred embodiment, the name of each cluster and the nodes are indicated. In addition, an indication of whether a particular node is passive is provided. Furthermore, the maximum number of nodes and the type of LAN adapter used for the interconnects within the clusters are provided. In one embodiment, the cluster type, such as high-availability or scalable, is also indicated. The method 250 is preferably performed after performance data for a plurality of monitors has been obtained. The plurality of monitors preferably includes CPU utilization, memory utilization, disk utilization and network utilization. The plurality of monitors might also include other monitors.

A computer system to be analyzed is selected, via step 252. If the computer system happens to be part of a cluster, than one node of the cluster is selected in step 252. Thus, a computer system, such as the computer system 120 or 140, or a node such as the nodes 112, 114, 132, 134 and 136 is selected in step 252. The first point in time having a particular amount of data is selected from the selected computer system, via step 254. In a preferred embodiment, the first time point having two hours of data is taken is selected in step 254. This point is selected so that an average can be calculated from the performance data.

The two hours of performance data for a first node in a cluster, or for the selected computer system if the selected computer system is-not a cluster, is then analyzed, via step 256. Step 256 analyzes the performance data for each monitor for the node or computer system. Step 256 also includes forecasting bottlenecks. If a bottleneck is found in the performance data for one or more monitors of the selected computer system, then a bottleneck object is created for that monitor of the selected computer system as part of step 256.

It is then determined if the selected computer system, or node, is part of a cluster, via step 258. If so, it is determined whether there are more nodes in the cluster, via step 259. If so, then the next node is selected, via step 260. Steps 256 though 260 are then repeated until the performance data for each of the nodes in the cluster has been analyzed.

It is then determined whether a bottleneck object has been created for the selected computer system, via step 262. If so and the selected computer system is part of a cluster, then information about the other, companion nodes in a cluster is added to the bottleneck object, via step 264. The information added in step 264 includes setting four counters for each companion node in the cluster. If the current node is down, then the first counter for each companion node is set to a one. If the current node is bottlenecked, then the second counter for each companion node is set to a one. If the companion node can absorb all of the workload from the (current) bottlenecked node, then the third counter is set to a one. If the companion node can absorb all of the workload from the (current) bottlenecked node only with other nodes, then the fourth counter for the companion node is set to a one. If not set to a one, then the counter remains a zero. Thus, information relating to companion nodes in the cluster is accounted for in the bottleneck object for the current node. In addition, when the companion nodes in the cluster are later analyzed, information for the current node is accounted for. Thus, nodes in a cluster are analyzed from two perspectives-from the nodes own perspective and from the perspective of other nodes in the cluster.

If it is determined that no bottleneck object was created, then it is determined whether the selected computer system is part of a cluster and, if so, whether the cluster is a fail-safe cluster, via step 266. A cluster is a fail-safe cluster if it is designed to prevent a total failure of the cluster. If the cluster is a fail-safe cluster, then it is determined whether other nodes in the cluster can absorb the load of the current node, via step 267. If the remaining nodes cannot absorb the load, then a new bottleneck object is created and a fail-over-risk counter is set to one, via step 268.

It is then determined whether the type of bottleneck created for the system in this analysis has previously been created for the system, via step 270. Note that step 270 is only performed when previous performance data exists for the selected computer system. Step 270 thus determines whether the current constraints to the performance of the selected computer system existed previously. If so, then the frequency of the existing bottleneck is incremented and the new bottleneck created is discarded, via step 272. In addition, the ending timestamp for the existing bottleneck is reset to the current time, via step 274. In addition, if the selected computer system is part of a cluster, then data for companion nodes in the cluster must be combined with the data for the current node, via step 276. Step 276 includes setting the counters for the companion nodes, as described in steps 264 and 268, for the existing bottleneck. If this type of bottleneck was not previously created, then the new bottleneck is added to the list of bottlenecks, via step 278.

It is then determined whether there is more performance data that can be analyzed, via step 280. In a preferred embodiment, step 280 determines whether there is two more hours of performance data. If so, then the next time point having two hours of performance data is obtained, via step 282. Step 256 is then returned to. If is determined that there is not additional performance data to be analyzed, then it is determined whether there are additional systems to be analyzed, via step 284. If so, then the next computer system is selected, via step 286. Step 254 is then returned to.

If there are no remaining systems, then the results are output. First, the computer systems are sorted so that the computer systems that are the most bottlenecked will have their data output first, via step 288. The first computer system is selected for output, via step 290. The computer system selected in step 290 may be a stand-alone computer system, such as the computer systems 120 or 130, or a node, such as the nodes 112, 114, 132, 134 and 136. The statistics relating to the system are then output, via step 292. The bottleneck objects are also sorted so that the most frequent bottleneck will be output first, via step 294. The first bottleneck is selected, via step 296. Data describing the bottleneck is then provided, via step 298. This data preferably includes the type of bottleneck, the monitors involved in the bottleneck, the total time that the system was bottlenecked, the starting time of the bottleneck and the ending time of the bottleneck. The remedies for the bottleneck are also provided, via step 300. For selected computer system that is part of a cluster, the remedies provided in step 300 can include cluster level remedies, as described above.

It is then determined whether there are additional bottleneck objects for the selected computer system, via step 302. If so, method goes to the next bottleneck, via step 304. The method then returns to step 298. If not, then it is determined whether there is an additional computer systems having data to be output, via step 306. If so, then the next system is selected, via step 308. The method then returns to step 292. Otherwise, the method terminates.

Using the method 250, performance data can be analyzed for the network 100. The results can also be provided to the user. Data for both clusters 110 and 130 and computer systems 120 and 140 can be obtained and analyzed. Furthermore, the appropriate remedies for performance issues can be provided for both the clusters 110 and 130 and the computer systems 130 and 140. Although not explicitly depicted in the method 250, the performance data as well as the remedies can be provided to the user, preferably through a GUI 154. Thus, a user can view the performance data and obtain remedies for issues such as bottlenecks. Consequently, a user can better control the network 100 to provide the desired performance.

A method and system has been disclosed for providing performance analysis on clusters. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for providing performance analysis on a system including a cluster, the cluster including a plurality of nodes, the method comprising the steps of:
(a) obtaining data for the plurality of nodes in the cluster, the data relating to a plurality of monitors for the node,
(b) analyzing the data to determine whether performance of the cluster can be improved;
(c) providing at least one remedy to improve performance of the cluster if the performance of the cluster can be improved, the at least one remedy capable of including a cluster level remedy.

2. The method of claim 1 wherein the data analyzing step (b) further includes the steps of:
(b1) determining whether a bottleneck exists for at least one monitor of the plurality of monitors for the plurality of nodes.

3. The method of claim 2 wherein the data analyzing step (b) further includes the step of:
(b2) determining whether a latent bottleneck exists for at least one monitor of the plurality of monitors for the plurality of nodes.

4. The method of claim 2 wherein the data analyzing step (b) further includes the step of:
(b2) forecasting a future bottleneck for at least one monitor of the plurality of monitors for the plurality of nodes.

5. The method of claim 1 wherein the plurality of monitors include disk utilization, CPU utilization, memory using and LAN.

6. The method of claim 1 wherein the cluster remedy is capable of including transferring a load from a first node of the plurality of nodes to a second node of the plurality of nodes.

7. The method of claim 1 wherein the cluster remedy is capable of including adding a new node to the plurality of nodes of the at least one cluster.

8. The method of claim 1 wherein the cluster remedy is capable of including warning that if a particular node of the plurality of nodes fails, at least one remaining node of the plurality of nodes may become bottlenecked.

9. The method of claim 1 the cluster remedy capable of including a notification that a companion node of the plurality of nodes may be a source of a bottleneck if another node of the plurality of nodes is bottlenecked.

10. The method of claim 1 wherein a node of the plurality of nodes carries a workload and has a bottleneck, wherein a companion node of the plurality of nodes is capable of supporting a portion of the workload, and wherein the cluster remedy is capable of including a notification that the portion of the workload can be moved to the companion node.

11. The method of claim 1 wherein if a node of the plurality of nodes fails, at least one remaining node of the plurality of nodes will become bottlenecked and wherein the cluster remedy is capable of including notification that if the node fails, the at least one remaining node of the plurality of nodes will become bottlenecked.

12. The method of claim 1 further comprising the step of:
(d) obtaining information relating to the cluster, the information including an indication of whether each of the plurality of nodes is a passive node, a maximum number of nodes in the cluster and a type of LAN adapter used for interconnecting the plurality of nodes.

13. A method for providing performance analysis on a network including a plurality of computer systems, the plurality of computer systems including a cluster, the cluster including a plurality of nodes, the method comprising the steps of:
(a) obtaining data for each of the plurality of computer systems, the data relating to a plurality of monitors for each of the plurality of computer systems;
(b) determining whether each of the plurality of computer systems is the cluster;
(c) if a computer system of the plurality of computer systems is the cluster, analyzing data for each of the plurality of nodes in the cluster to determine whether performance of the cluster can be improved;
(d) if the computer system of the plurality of computer systems is not the cluster, then analyzing data for the computer system to determine whether the performance of the computer system can be improved; and
(e) providing at least one remedy to improve performance of the network if the performance of the network can be improved, the at least one remedy capable of including a cluster level remedy only for the cluster.

14. A computer-readable medium including a program for providing performance analysis on a system including a cluster, the cluster including a plurality of nodes, the program including instructions for:
(a) obtaining data for each node of the plurality of nodes in the cluster, the data relating to a plurality of monitors for the node,
(b) analyzing the data to determine whether performance of the cluster can be improved; and
(c) providing at least one remedy to improve performance of the cluster if the performance of the cluster can be improved, the at least one remedy capable of including a cluster level remedy.

15. A system programmed to provide performance analysis on a network including a plurality of systems, the plurality of systems including a cluster, the cluster including a plurality of nodes, the system comprising:
means for obtaining data for each node of the plurality of nodes in the cluster, the data relating to a plurality of monitors for the node and for analyzing the data to determine whether performance of the cluster can be improved; and
a graphical user interface for displaying at least one remedy to improve performance of the cluster if the performance of the cluster can be improved, the at least one remedy capable of including a cluster level remedy.

16. The system of claim 15 wherein the obtaining and analyzing means further include a plurality of agents residing in the plurality of computer systems.
